(19) United States
(12) Patent Application Publication
(10) Pub. No.: US 2016/0286132 A1
(43) Pub. Date: Sep. 29, 2016

(54) ELECTRONIC DEVICE AND METHOD FOR PHOTOGRAPHING

(71) Applicant: Samsung Electronics Co., Ltd., Gyeonggi-do (KR)

(72) Inventors: Junghyung Kim, Gyeonggi-do (KR); Pyeonggyu Jin, Gyeonggi-do (KR); Jonghyun Park, Gyeonggi-do (KR); Younggyun Im, Gyeonggi-do (KR)

(21) Appl. No.: 15/080,423

(22) Filed: Mar. 24, 2016

(30) Foreign Application Priority Data
Mar. 24, 2015 (KR) 10-2015-0040934

(51) Int. Cl. H04N 5/232; H04N 5/225; H04N 5/262

(52) U.S. Cl. CPC H04N 5/23293; H04N 5/23222; H04N 5/2628; H04N 5/2257

(57) ABSTRACT

A method for photographing in an electronic device according to various embodiments of the present disclosure includes displaying a preview image on a display, identifying at least one of current location information, environment information, and information related to the preview image of the electronic device, and searching and obtaining photographing information based on the identified information. An electronic device includes a communication module, a camera module, a display, a memory, and a processor, wherein the processor is configured to control to display a preview image obtained from the camera module on the display, identify at least one of current location information, environment information, and information related to the preview image, and search for and obtain photographing information through the communication module based on the identified information.

### CROSS-REFERENCE TO RELATED APPLICATION AND CLAIM OF PRIORITY

The present application is related to and claims benefit under 35 U.S.C. §119(a) of a Korean patent application filed on Mar. 24, 2015, in the Korean Intellectual Property Office and assigned Serial No. 10-2015-0040934, the entire disclosure of which is hereby incorporated by reference.

### TECHNICAL FIELD

The present disclosure relates to a method for photographing having a user guide function and an electronic device using the same.

### BACKGROUND

Electronic devices for processing an image, such as a digital camera and a device including a camera function, provide a photographing guide for a user by adjusting color information of a subject in real time or post-processing by recognizing a photographed image.

However, such a method cannot provide a sufficient guide for a user in order to take an optimum photograph in real time. For example, a user must learn a professional photographing technology to control photographing information of a subject in real time, and the user may experience difficulties in obtaining an optimum image in real time, because the photographing method of the electronic device is obtained by comparing and evaluating a photographed image with other images in case of using the post-processing method.

### SUMMARY

To address the above-discussed deficiencies, it is a primary object to provide an electronic device and a method for photographing.

The present disclosure relates to an electronic device and a method for photographing, and provides diversified photographing information for a user.

A method for photographing in an electronic device according to various embodiments of the present disclosure may include: displaying a preview image on a display; identifying at least one of current location information, environment information, and information related to the preview image of the electronic device; and searching and obtaining photographing information based on the identified information.

An electronic device according to various embodiments of the present disclosure may include: a communication module, a camera module, a display, a memory, and a processor. The processor controls to display a preview image obtained from the camera module on the display, to identify at least one of current location information, environment information, and information related to the preview image, and to search and obtain photographing information through the communication module based on the identified information.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating an electronic device in a network environment according to various embodiments of the present disclosure;

FIG. 2 is a block diagram illustrating a configuration of an electronic device according to various embodiments of the present disclosure;

FIG. 3 is a block diagram illustrating a configuration of a program module according to various embodiments of the present disclosure;

FIG. 4 is a flowchart illustrating a method for photographing in an electronic device according to various embodiments of the present disclosure;

FIG. 5 is a schematic drawing illustrating a method for photographing in an electronic device according to various embodiments of the present disclosure;

FIG. 6 is a flowchart illustrating a method for photographing in an electronic device according to various embodiments of the present disclosure;

FIG. 7 is a schematic drawing illustrating a method for photographing in an electronic device according to various embodiments of the present disclosure;

FIG. 8 is a flowchart illustrating a method for photographing in an electronic device according to various embodiments of the present disclosure; and

FIG. 9 is a schematic drawing illustrating a method for photographing in an electronic device according to various embodiments of the present disclosure.

### DETAILED DESCRIPTION

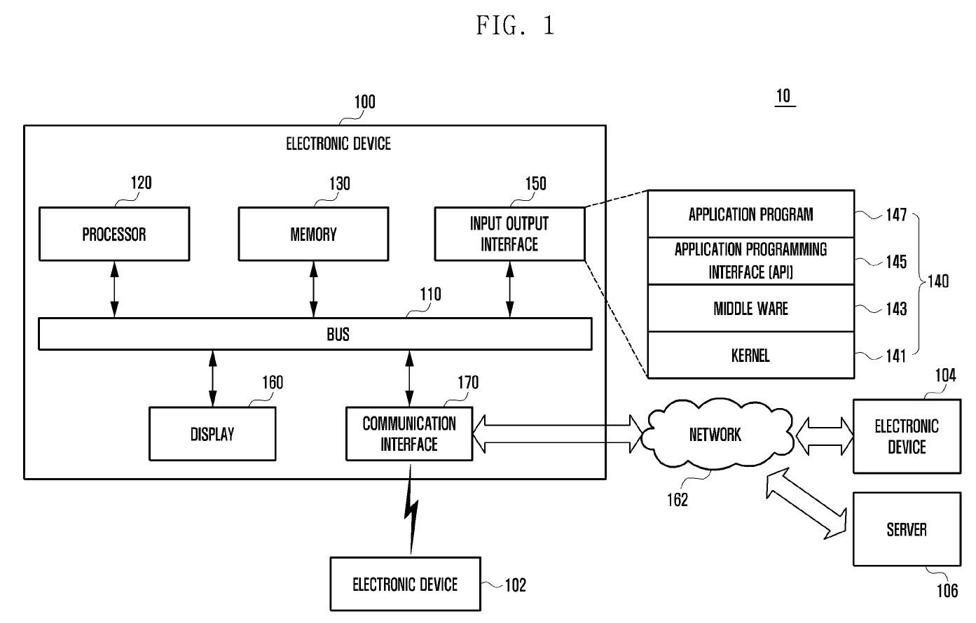

FIGS. 1 through 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged electronic devices capable of photographing. Hereinafter, the present disclosure will be described with reference to the accompanying drawings. Although specific embodiments are illustrated in the drawings and related detailed descriptions are discussed in the present specification, the present disclosure may have various modifications and several embodiments. However, various embodiments of the present disclosure are not limited to a specific implementation form and it should be understood that the present disclosure includes all changes and/or equivalents and substitutes included in the spirit and scope of various embodiments of the present disclosure. In connection with descriptions of the drawings, similar components are designated by the same reference numeral.

The term “include” or “may include” which may be used in describing various embodiments of the present disclosure refers to the existence of a corresponding disclosed function, operation or component which can be used in various embodiments of the present disclosure and does not limit one or more additional functions, operations, or components. In various embodiments of the present disclosure, the terms such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

In various embodiments of the present disclosure, the expression “or” or “at least one of A or/and B” includes any or all of combinations of words listed together. For example, the expression “A or B” or “at least A or/and B” may include A, may include B, or may include both A and B.

The expression “1”, “2”, “first”, or “second” used in various embodiments of the present disclosure may modify various components of the various embodiments but does not limit the corresponding components. For example, the above expressions do not limit the sequence and/or importance of the components. The expressions may be used for distinguishing one component from other components. For example, a first user device and a second user device indicate different user devices although both of them are user devices. For example, without departing from the scope of the present disclosure, a first structural element may be referred to as a second structural element. Similarly, the second structural element also may be referred to as the first structural element.

When it is stated that a component is “coupled to” or “connected to” another component, the component may be directly coupled or connected to another component or a new component may exist between the component and another component. In contrast, when it is stated that a component is “directly coupled to” or “directly connected to” another component, a new component does not exist between the component and another component.

The terms used in describing various embodiments of the present disclosure are only examples for describing a specific embodiment but do not limit the various embodiments of the present disclosure. Singular forms are intended to include plural forms unless the context clearly indicates otherwise.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present description.

An electronic device according to various embodiments of the present disclosure can be a device including a communication function. For example, the electronic device can be one or a combination of a smart phone, a tablet Personal Computer (PC), a mobile phone, a video phone, an e-book reader, a desktop PC, a laptop PC, a netbook computer, a Personal Digital Assistant (PDA), a camera, a wearable device (for example, a Head-Mounted-Device (HMD) such as electronic glasses, electronic clothes, and electronic bracelet, an electronic necklace, an electronic appcessary, an electronic tattoo, and a smart watch.

According to some embodiments, the electronic device can be a smart home appliance having a communication function. The smart home appliance can include at least one of a TeleVision (TV), a Digital Video Disk (DVD) player, an audio player, an air conditioner, a cleaner, an oven, a microwave oven, a washing machine, an air cleaner, a set-top box, a TV box (for example, Samsung HomeSync™, Apple TV™, or Google TV™), game consoles, an electronic dictionary, an electronic key, a camcorder, and an electronic frame.

According to some embodiments, the electronic device can include at least one of various types of medical devices (for example, Magnetic Resonance Angiography (MRA), Magnetic Resonance Imaging (MRI), Computed Tomography (CT), a scanner, an ultrasonic device and the like), a navigation device, a Global Positioning System (GPS) receiver, an Event Data Recorder (EDR), a Flight Data Recorder (FDR), a vehicle infotainment device, electronic equipment for a ship (for example, a navigation device for ship, a gyro compass and the like), avionics, a security device, a head unit for a vehicle, an industrial or home robot, an Automatic Teller Machine (ATM) of financial institutions, and a Point Of Sale (POS) device of shops.

According to some embodiments, the electronic device can include at least one of furniture or a part of a building/structure, an electronic board, an electronic signature receiving device, a projector, and various types of measuring devices (for example, a water meter, an electricity meter, a gas meter, a radio wave meter and the like) including a camera function. The electronic device according to various embodiments of the present disclosure can be one or a combination of the above described various devices. Further, the electronic device according to various embodiments of the present disclosure can be a flexible device. It is apparent to those skilled in the art that the electronic device according to various embodiments of the present disclosure is not limited to the above described devices.

Hereinafter, an electronic device according to various embodiments of the present disclosure will be described with reference to the accompanying drawings. The term “user” used in various embodiments can refer to a person who uses an electronic device or a device (for example, an artificial intelligence electronic device) which uses an electronic device.

According to one embodiment of the present disclosure, a screen of an electronic device can be split into at least two windows according to a predefined split manner and displayed through a display of an electronic device. The windows are defined as split windows. According to one embodiment, the split windows are defined as windows displayed on a display of an electronic display not to be superposed one on another.

According to one embodiment, a popup window is defined as a window displayed on a display of an electronic device to hide or to be superposed on a portion of a screen under execution.

According to one embodiment of the present disclosure, an electronic device using split window and a popup window is capable of displaying two or more application execution screens or function execution screens. Thus, the split windows and the popup window are defined as a multi-window.

Hereinafter, an electronic device according to various embodiments will be described with reference to the accompanying drawings. As used herein, the term “user” can indicate a person who uses an electronic device or a device (e.g., an artificial intelligence electronic device) that uses an electronic device.

FIG. 1 illustrates a network environment 10 including an electronic device 101 according to various embodiments of the present disclosure. Referring to FIG. 1, the electronic device 100 includes a bus 110, a processor 120, a memory 130, a user input module 150, a display module 160 and a communication module 170.

The bus 110 can be a circuit connecting the above described components and transmitting communication (for example, a control message) between the above described components. The processor 120 receives commands from other components (for example, the memory 130, the user input module 150, the display module 160, the communication module 170) through the bus 110, analyzes the received commands, and executes calculation or data processing according to the analyzed commands. The memory 130 stores commands or data received from the processor 120 or other components (for example, the user input module 150, the display module 160, or the communication module 170) or generated by the processor 120 or other components. The memory 130 can include programming modules 140, for example, a kernel 141, middleware 143, an Application Programming Interface (API) 145, and an application 147. Each of the aforementioned programming modules can be implemented by software, firmware, hardware, or a combination of two or more thereof.

The kernel 141 controls or manages system resources (for example, the bus 110, the processor 120, or the memory 130) used for executing an operation or function implemented by the remaining other programming modules, for example, the middleware 143, the API 145, or the application 147. Further, the kernel 141 provides an interface for accessing individual components of the electronic device 101 from the middleware 143, the API 145, or the application 147 to control or manage the components. The middleware 143 performs a relay function of allowing the API 145 or the application 147 to communicate with the kernel 141 to exchange data. Further, in operation requests received from the application 147, the middleware 143 performs a control for the operation requests (for example, scheduling or load balancing) by using a method of assigning a priority, by which system resources (for example, the bus 110, the processor 120, the memory 130 and the like) of the electronic device 100 can be used, to the application 134.

The API 145 is an interface by which the application 147 can control a function provided by the kernel 141 or the middleware 143 and includes, for example, at least one interface or function (for example, command) for a file control, a window control, image processing, or a character control. The user input module 150 can receive, for example, a command and/or data from a user, and transfer the received command and/or data to the processor 120 and/or the memory 130 through the bus 110. The display module 160 can display an image, a video, and/or data to a user.

According to an embodiment, the display module 160 can display a graphic user interface image for interaction between the user and the electronic device 100. According to various embodiments, the graphic user interface image can include interface information to activate a function for correcting color of the image to be projected onto the screen. The interface information can be in the form of, for example, a button, a menu, or an icon. The communication module 170 connects communication between the electronic device 100 and the external device (for example, electronic device 102, 104 or server 106). For example, the communication interface 160 can access a network 162 through wireless or wired communication to communicate with the external device. The wireless communication includes at least one of, for example, WiFi, BlueTooth (BT), Near Field Communication (NFC), a Global Positioning System (GPS), and cellular communication (for example, LTE, LTE-A, CDMA, WCDMA, UMTS, WiBro or GSM). The wired communication can include at least one of, for example, a Universal Serial Bus (USB), a High Definition Multimedia Interface (HDMI), Recommended Standard 232 (RS-232), and a Plain Old Telephone Service (POTS).

According to an embodiment, the server 106 supports driving of the electronic device 100 by performing at least one operation (or function) implemented by the electronic device 100. For example, the server 106 can include a communication control server module that supports the communication module 170 implemented in the electronic device 100. For example, the communication control server module can include at least one of the components of the communication module 170 to perform (on behalf of) at least one operations performed by the communication module 170.

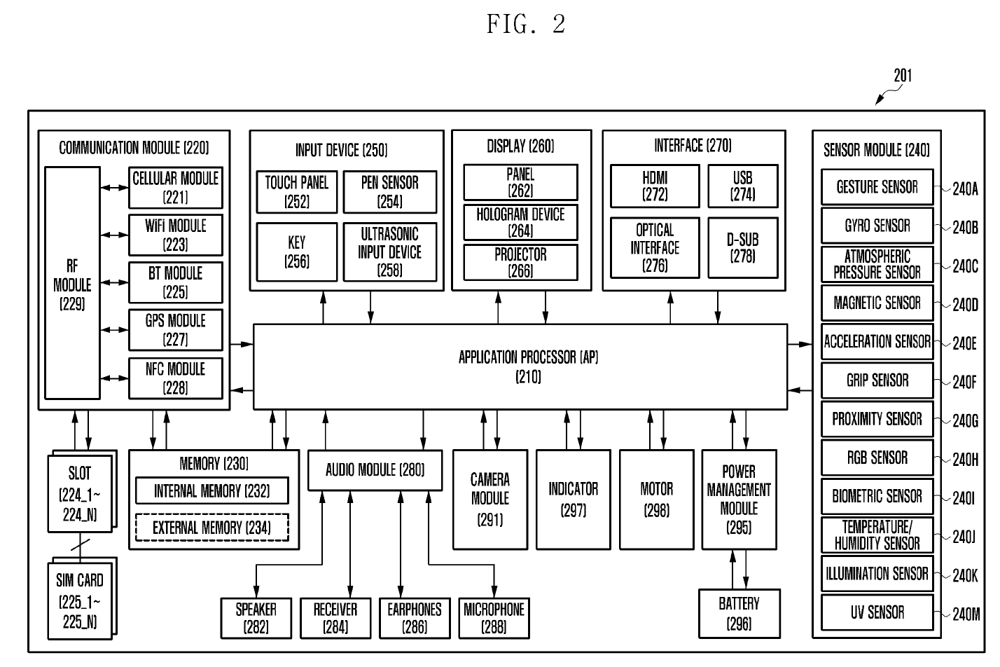

FIG. 2 is a block diagram 200 of an electronic device 200 according to various embodiments of the present disclosure. The electronic device 200 can configure, for example, a whole or a part of the electronic device 100 illustrated in FIG. 1. Referring to FIG. 1, the electronic device 200 includes one or more Application Processors (APs) 210, a communication module 220, a Subscriber Identification Module (SIM) card 224, a memory 230, a sensor module 240, an input device 250, a display 260, an interface 270, an audio module 280, a camera module 291, a power managing module 295, a battery 296, an indicator 297, and a motor 298.

The AP 210 operates an operating system (OS) or an application program so as to control a plurality of hardware or software component elements connected to the AP 210 and execute various data processing and calculations including multimedia data. The AP 210 can be implemented by, for example, a System on Chip (SoC). According to an embodiment, the processor 210 can further include a Graphic Processing Unit (GPU).

The communication module 220 (for example, communication module 170) transmits/receives data in communication between different electronic devices (for example, the electronic device 104 and the server 106) connected to the electronic device 200 (for example, electronic device 100) through a network. According to an embodiment, the communication module 220 includes a cellular module 221, a WiFi module 223, a BlueTooth (BT) module 225, a Global Positioning System (GPS) module 227, a Near Field Communication (NFC) module 228, and a Radio Frequency (RF) module 229.

The cellular module 221 provides a voice, a call, a video call, a Short Message Service (SMS), or an Internet service through a communication network (for example, Long Term Evolution (LTE), LTE-A, Code Division Multiple Access (CDMA), Wideband CDMA (WCDMA), UMTS, WiBro, GSM or the like). Further, the cellular module 221 can distinguish and authenticate electronic devices within a communication network by using a subscriber identification module (for example, the SIM card 224). According to an embodiment, the cellular module 221 performs at least some of the functions which can be provided by the AP 210. For example, the cellular module 221 can perform at least some of the multimedia control functions.

According to an embodiment, the cellular module 221 can include a Communication Processor (CP). Further, the cellular module 221 can be implemented by, for example, an SoC.

According to an embodiment, the AP 210 or the cellular module 221 (for example, communication processor) can load a command or data received from at least one of a non-volatile memory and other components connected to each of the AP 210 and the cellular module 221 to a volatile memory and process the loaded command or data. Further, the AP 210 or the cellular module 221 can store data received from at least one of other components or generated by at least one of other components in a non-volatile memory.

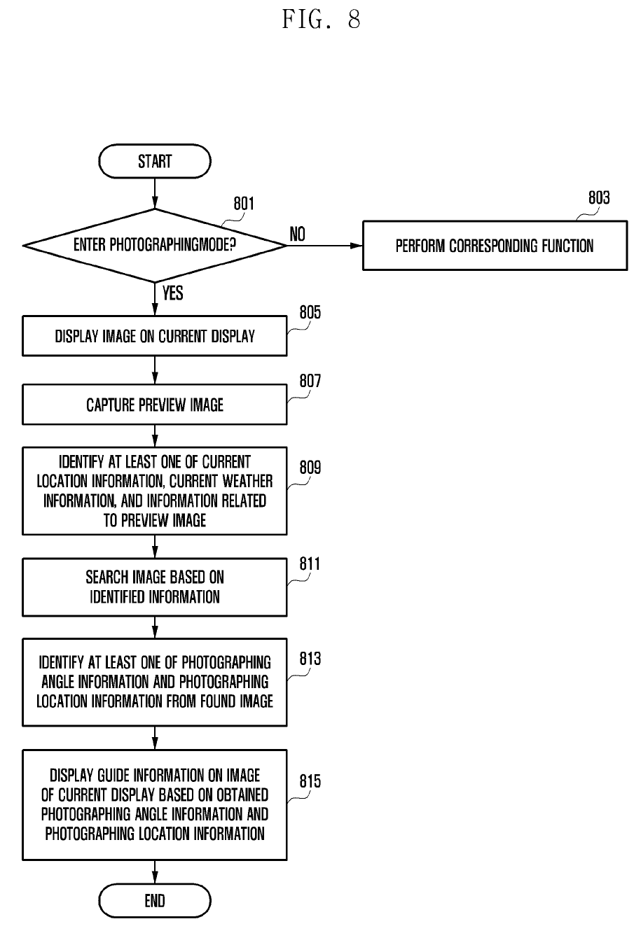

Each of the WiFi module 223, the BT module 225, the GPS module 227, and the NFC module 228 can include, for example, a processor for processing data transmitted/received through the corresponding module. Although the cellular module 221, the WiFi module 223, the BT module 225, the GPS module 227, and the NFC module 228 are illustrated as blocks separate from each other in FIG. 8, at least some (for example, two or more) of the cellular module 221, the WiFi module 223, the BT module 225, the GPS module 227, and the NFC module 228 can be included in one Integrated Chip (IC) or one IC package according to one embodiment. For example, at least some (for example, the communication processor corresponding to the cellular module 221 and the WiFi processor corresponding to the WiFi module 223) of the processors corresponding to the cellular module 221, the WiFi module 223, the BT module 225, the GPS module 227, and the NFC module 228 can be implemented by one SoC.

The RF module 229 transmits/receives data, for example, an RF signal. Although not illustrated, the RF module 229 can include, for example, a transceiver, a Power Amp Module (PAM), a frequency filter, a Low Noise Amplifier (LNA) or the like. Further, the RF module 229 can further include a component for transmitting/receiving electronic waves over a free air space in wireless communication, for example, a conductor, a conducting wire, or the like. Although the cellular module 221, the WiFi module 223, the BT module 225, the GPS module 227, and the NFC module 228 share one RF module 229 in FIG. 2, at least one of the cellular module 221, the WiFi module 223, the BT module 225, the GPS module 227, and the NFC module 228 can transmit/receive an RF signal through a separate RF module according to one embodiment.

The SIM card 224 is a card including a Subscriber Identification Module and can be inserted into a slot formed in a particular portion of the electronic device. The SIM card 224 includes unique identification information (for example, Integrated Circuit Card IDentifier (ICCID)) or subscriber information (for example, International Mobile Subscriber Identity (IMSI).

The memory 230 (for example, memory 130) can include an internal memory 232 or an external memory 234. The internal memory 232 can include, for example, at least one of a volatile memory (for example, a Random Access Memory (RAM), a dynamic RAM (DRAM), a static RAM (SRAM), a synchronous dynamic RAM (SDRAM), and the like), and a non-volatile Memory (for example, a Read Only Memory (ROM), a one time programmable ROM (OTPROM), a programmable ROM (PROM), an erasable and programmable ROM (EPROM), an electrically erasable and programmable ROM (EEPROM), a mask ROM, a flash ROM, a NAND flash memory, an NOR flash memory, and the like).

According to an embodiment, the internal memory 232 can be a Solid State Drive (SSD). The external memory 234 can further include a flash drive, for example, a Compact Flash (CF), a Secure Digital (SD), a Micro Secure Digital (Micro-SD), a Mini Secure Digital (Mini-SD), an extreme Digital (xD), or a memory stick. The external memory 234 can be functionally connected to the electronic device 200 through various interfaces. According to an embodiment, the electronic device 200 can further include a storage device (or storage medium) such as a hard drive.

The sensor module 240 measures a physical quantity or detects an operation state of the electronic device 201, and converts the measured or detected information to an electronic signal. The sensor module 240 can include, for example, at least one of a gesture sensor 240A, a gyro sensor 240B, an atmospheric pressure (barometric) sensor 240C, a magnetic sensor 240D, an acceleration sensor 240E, a grip sensor 240F, a proximity sensor 240G, a color sensor 240H (for example, Red, Green, and Blue (RGB) sensor) 240H, a biometric sensor 240I, a temperature/humidity sensor 240J, an illumination (light) sensor 240K, and a Ultra Violet (UV) sensor 240M. Additionally or alternatively, the sensor module 240 can include, for example, a E-nose sensor, an electromyography (EMG) sensor, an electroencephalogram (EEG) sensor, an electrocardiogram (ECG) sensor, an InfraRed (IR) sensor, an iris sensor, a fingerprint sensor (not illustrated), and the like. The sensor module 240 can further include a control circuit for controlling one or more sensors included in the sensor module 240.

The input device 250 includes a touch panel 252, a (digital) pen sensor 254, a key 256, and an ultrasonic input device 258. For example, the touch panel 252 can recognize a touch input in at least one type of a capacitive type, a resistive type, an infrared type, and an acoustic wave type. The touch panel 252 can further include a control circuit. In the capacitive type, the touch panel 252 can recognize proximity as well as a direct touch. The touch panel 252 can further include a tactile layer. In this event, the touch panel 252 provides a tactile reaction to the user.

The (digital) pen sensor 254 can be implemented, for example, using a method identical or similar to a method of receiving a touch input of the user, or using a separate recognition sheet. The key 256 can include, for example, a physical button, an optical key, or a key pad. The ultrasonic input device 258 is a device which can detect an acoustic wave by a microphone (for example, microphone 288) of the electronic device 200 through an input means generating an ultrasonic signal to identify data and can perform wireless recognition. According to an embodiment, the electronic device 200 receives a user input from an external device (for example, computer or server) connected to the electronic device 200 by using the communication module 220.

The display 260 (for example, display module 160) includes a panel 262, a hologram device 264, and a projector 266. The panel 262 can be, for example, a Liquid Crystal Display (LCD) or an Active Matrix Organic Light Emitting Diode (AM-OLED). The panel 262 can be implemented to be, for example, flexible, transparent, or wearable. The panel 262 can be configured by the touch panel 252 and one module. The hologram device 264 shows a stereoscopic image in the air by using interference of light. The projector 266 projects light on a screen to display an image. For example, the screen can be located inside or outside the electronic device 200. According to an embodiment, the display 260 can further include a control circuit for controlling the panel 262, the hologram device 264, and the projector 266.

The interface 270 includes, for example, a High-Definition Multimedia Interface (HDMI) 272, a Universal Serial Bus (USB) 274, an optical interface 276, and a D-subminiature (D-sub) 278. The interface 270 can be included in, for example, the communication module 170 illustrated in FIG. 1. Additionally or alternatively, the interface 290 can include, for example, a Mobile High-definition Link (MHL) interface, a Secure Digital (SD) card/Multi-Media Card (MMC), or an Infrared Data Association (IrDA) standard interface.

The audio module 280 bi-directionally converts a sound and an electronic signal. At least some components of the audio module 280 can be included in, for example, the user input module 150 illustrated in FIG. 1. The audio module 280 processes sound information input or output through, for example, a speaker 282, a receiver 284, an earphone 286, the microphone 288 or the like.

The camera module 291 is a device which can photograph a still image and a video. According to an embodiment, the camera module 291 can include one or more image sensors (for example, a front sensor or a back sensor), an Image Signal Processor (ISP) (not shown) or a flash (for example, an LED or xenon lamp).

The power managing module 295 manages power of the electronic device 200. Although not illustrated, the power managing module 295 can include, for example, a Power Management Integrated Circuit (PMIC), a charger Integrated Circuit (IC), or a battery or fuel gauge.

The PMIC can be mounted to, for example, an integrated circuit or an SoC semiconductor. A charging method can be divided into wired and wireless methods. The charger IC charges a battery and prevent over voltage or over current from flowing from a charger. According to an embodiment, the charger IC includes a charger IC for at least one of the wired charging method and the wireless charging method. The wireless charging method can include, for example, a magnetic resonance method, a magnetic induction method and an electromagnetic wave method, and additional circuits for wireless charging, for example, circuits such as a coil loop, a resonant circuit, a rectifier or the like can be added.

The battery fuel gauge measures, for example, a remaining quantity of the battery 296, or a voltage, a current, or a temperature during charging. The battery 296 can store or generate electricity and supply power to the electronic device 200 by using the stored or generated electricity. The battery 296 can include a rechargeable battery or a solar battery. The indicator 297 shows particular statuses of the electronic device 200 or a part (for example, AP 210) of the electronic device 200, for example, a booting status, a message status, a charging status and the like. The motor 298 converts an electrical signal to a mechanical vibration.

Although not illustrated, the electronic device 200 can include a processing unit (for example, GPU) for supporting a module TV. The processing unit for supporting the mobile TV can process, for example, media data according to a standard of Digital Multimedia Broadcasting (DMB), Digital Video Broadcasting (DVB), media flow or the like.

Each of the components of the electronic device according to various embodiments of the present disclosure can be implemented by one or more components and the name of the corresponding component can vary depending on a type of the electronic device. The electronic device according to various embodiments of the present disclosure can include at least one of the above described components, a few of the components can be omitted, or additional components can be further included. Also, some of the components of the electronic device according to various embodiments of the present disclosure can be combined to form a single entity, and thus can equivalently execute functions of the corresponding components before being combined.

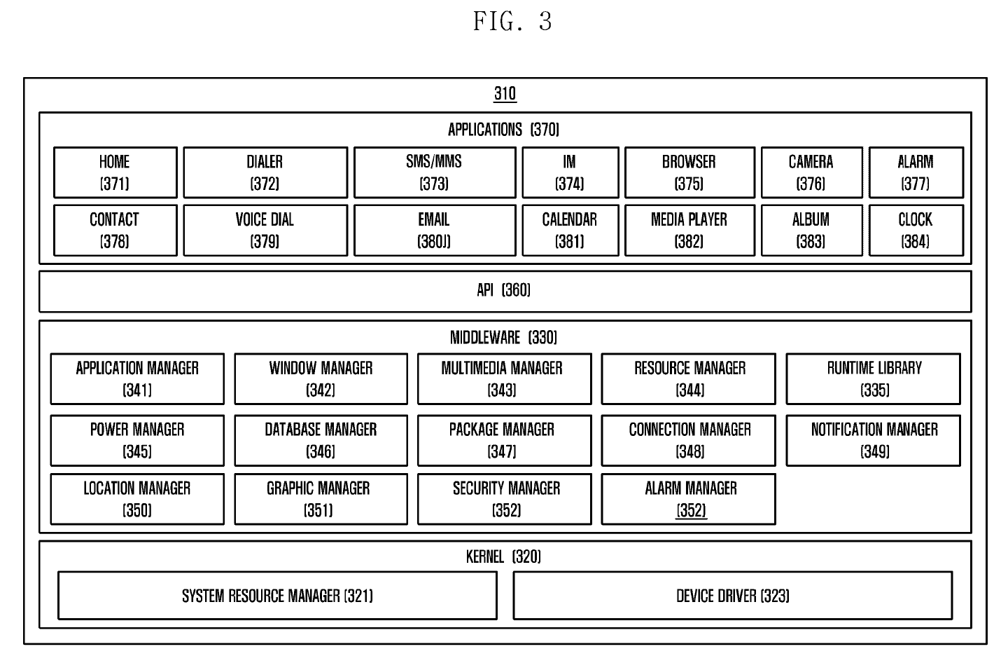

FIG. 3 is a block diagram of a programming module 310 according to an embodiment. The programming module 310 (for example, programming module 140) can be included (stored) in the electronic device 100 (for example, memory 130) illustrated in FIG. 1. At least some of the programming module 310 can be formed of software, firmware, hardware, or a combination of at least two of software, firmware, and hardware. The programming module 310 can be executed in the hardware (for example, electronic device 200) to include an Operating System (OS) controlling resources related to the electronic device (for example, electronic device 100) or various applications (for example, applications 370) driving on the OS. For example, the OS can be Android, iOS, Windows, Symbian, Tizen, Bada or the like. Referring to FIG. 3, the programming module 310 includes a kernel 320, a middleware 330, an Application Programming Interface (API) 360, and applications 370.

The kernel 320 (for example, kernel 141) includes a system resource manager 321 and a device driver 323. The system resource manager 321 can include, for example, a process manager, a memory manager, and a file system manager. The system resource manager 321 performs a system resource control, allocation, and recall. The device driver 323 can include, for example, a display driver, a camera driver, a Bluetooth driver, a shared memory driver, a USB driver, a keypad driver, a WiFi driver, and an audio driver. Further, according to an embodiment, the device driver 323 can include an Inter-Process Communication (IPC) driver. The middleware 330 includes a plurality of modules prepared in advance to provide a function required in common by the applications 370. Further, the middleware 330 provides a function through the API 360 to allow the application 370 to efficiently use limited system resources within the electronic device. For example, as illustrated in FIG. 3, the middleware 300 (for example, middleware 143) includes at least one of a runtime library 335, an application manager 341, a window manager 342, a multimedia manager 343, a resource manager 344, a power manager 345, a database manager 346, a package manager 347, a connection manager 348, a notification manager 349, a location manager 350, a graphic manager 351, and a security manager 352. The runtime library 335 includes, for example, a library module used by a complier to add a new function through a programming language while the application 370 is executed. According to an embodiment, the runtime library 335 executes input and output, management of a memory, a function associated with an arithmetic function and the like. The application manager 341 manages, for example, a life cycle of at least one of the applications 370. The window manager 342 manages GUI resources used on the screen. The multimedia manager 343 detects a format required for reproducing various media files and performs an encoding or a decoding of a media file by using a codec suitable for the corresponding format. The resource manager 344 manages resources such as a source code, a memory, or a storage space of at least one of the applications 370.

The power manager 345 operates together with a Basic Input/Output System (BIOS) to manage a battery or power and provides power information required for the operation. The database manager 346 manages generation, search, and change of a database to be used by at least one of the applications 370. The package manager 347 manages an installation or an update of an application distributed in a form of a package file.

The connection manager 348 manages, for example, a wireless connection such as WiFi or Bluetooth. The notification manager 349 displays or notifies a user of an event such as an arrival message, an appointment, a proximity alarm or the like, in a manner that does not disturb the user. The location manager 350 manages location information of the electronic device. The graphic manager 351 manages a graphic effect provided to the user or a user interface related to the graphic effect. The security manager 352 provides a general security function required for a system security or a user authentication. According to an embodiment, when the electronic device (for example, electronic device 100 or 200) has a call function, the middleware 330 can further include a telephony manager for managing a voice of the electronic device or a video call function. The middleware 330 can generate a new middleware module through a combination of various functions of the aforementioned internal component modules and use the generated new middleware module. The middleware 330 can provide a module specified for each type of operating system to provide a differentiated function. Further, the middleware 330 can dynamically delete some of the conventional components or add new components. Accordingly, some of the components described in the embodiment of the present disclosure can be omitted, replaced with other components having different names but performing similar functions, or other components can be further included.

The API 360 (for example, API 145) is a set of API programming functions, and can be provided with a different configuration according to an operating system. For example, in Android or iOS, a single API set can be provided for each platform. In Tizen, two or more API sets can be provided. The applications 370, which can include an application similar to the application 134, can include, for example, a preloaded application and/or a third party application. The applications 370 can include a home application 371 a dialer application 372, a Short Messaging Service (SMS)/Multimedia Messaging Service (MMS) application 373, an Instant Messaging (IM) application 374, a browser application 375, a camera application 376, an alarm application 377, a contact application 378, a voice dial application 379, an email application 380, a calendar application 381, a media player application 382, an album application 383, and a clock application 384. However, the present embodiment is not limited thereto, and the applications 370 can include any other similar and/or suitable application. At least a part of the programming module 310 can be implemented by commands stored in computer-readable storage media. When the commands are executed by at least one processor, e.g. the AP 210, at least one processor can perform functions corresponding to the commands. The computer-readable storage media can be, for example, the memory 230. At least a part of the programming module 310 can be implemented, e.g. executed, by, for example, the AP 210. At least a part of the programming module 310 can include, for example, a module, a program, a routine, a set of instructions and/or a process for performing at least one function.

The titles of the aforementioned elements of the programming module, e.g. the programming module 300, according to the present disclosure can vary depending on the type of the OS. The programming module according to the present disclosure can include at least one of the aforementioned elements and/or can further include other additional elements, and/or some of the aforementioned elements can be omitted. The operations performed by a programming module and/or other elements according to the present disclosure can be processed through a sequential, parallel, repetitive, and/or heuristic method, and some of the operations can be omitted and/or other operations can be added.

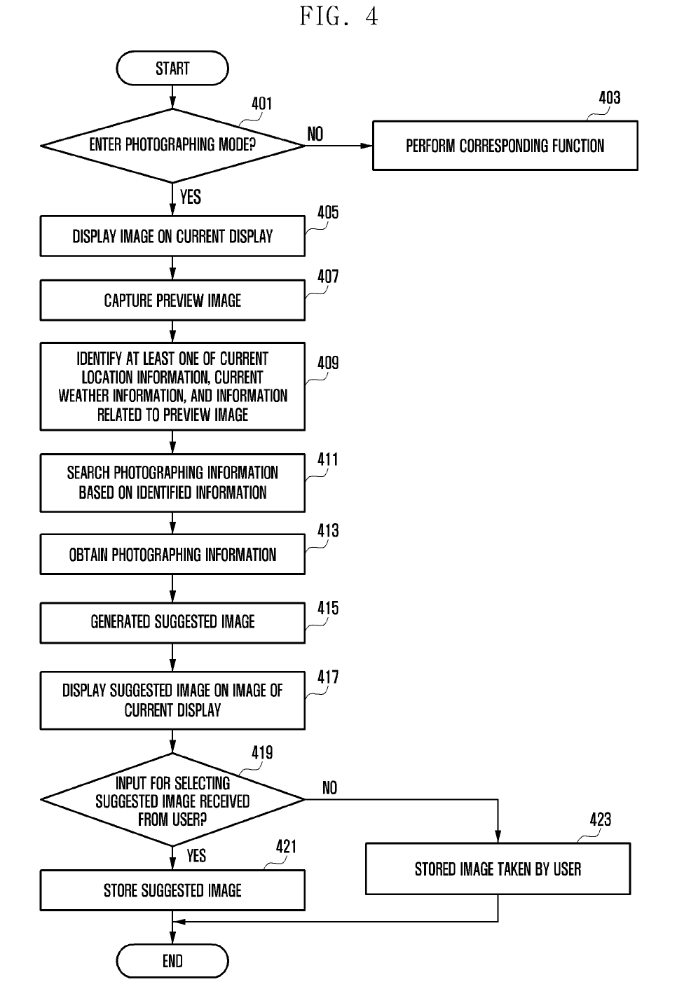

FIG. 4 is a flowchart illustrating a method for photographing in an electronic device 200 according to various embodiments of the present disclosure.

The electronic device 200 identifies entering a photographing mode at step 401. If a request for performing a photographing operation through a camera module 291 is received from a user, a processor 120 of the electronic device 200 can control a camera module 291 to operate correspondingly.

In various embodiments of the present disclosure, if the request for performing a photographing operation through the camera module 291 is received from the user, the processor 120 can control the operation of the camera module 291 and a camera application 376.

In various embodiments, if a request for executing the camera application 376 is received, the camera module 291 and the camera application 376 can operate under the control of the processor 120 of the electronic device 200.

If not entered the photographing mode, the electronic device 200 branches off to step 403 and performs a corresponding function which is being executed.

If entered the photographing mode, the electronic device 200 displays an image currently being displayed in the display 260 as a preview image at step 405.

In various embodiments, the processor 120 can display a preview image in the display 260 by properly converting an image input received through a lens and a camera sensor of the camera module 291 according to a predetermined output frame rate. For example, the preview image can be a still image or a moving image.

The electronic device 200 captures a preview image at step 407.

In various embodiments, the electronic device 200 can capture a preview image being displayed in the display 260. If a user doesn't give a command for capturing the image currently being displayed in the display 260 for a predetermined time, the electronic device 200 can store the image currently being displayed in the display 260.

In various embodiments, when the electronic device 200 captures a preview image, the electronic device 200 may not notify the capturing a preview image to a user. Alternatively, when the electronic device 200 captures a preview image, the electronic device 200 can output an alarm sound through an audio module 280 or an alarm image through the display 260 so that the user can recognize the capturing a preview image.

An electronic device 100 identifies at least one of current location information, environment information (for example, weather information), and information related to the preview image of the electronic device 200 at step 409.

The electronic device 200 can collect information related to a geographical location of the electronic device 200 through a communication module. For example, the processor 120 can identify the current location of the electronic device 200 through a GPS module 227. The GPS module 227 can receive a latitude, longitude, altitude, and direction of the electronic device 200 from satellites under the control of the processor 120.

The electronic device 200 can collect information related to a position or a posture of the electronic device 200 through a sensor module 240. For example, the processor 120 can collect information of a declination, location, and posture of an electronic device 240 by using a gesture sensor 240A, gyro sensor 240B, and/or acceleration sensor 240E included in the sensor module 240.

In various embodiments, the current location information of the electronic device 200 identified at step 409 can include information related to a geometrical location and/or information related to a position or a posture of the electronic device 200.

In various embodiments, the electronic device 200 can collect environment information (for example, weather information) by using an air pressure sensor 240C and/or a temperature/humidity sensor 240J. The electronic device 200 can collect environment information (for example, weather information) corresponding to the information related to a geometrical location of the electronic device 200 through a network 162. For example, the electronic device 200 can collect environment information (for example, weather information) corresponding to the information related to a geometrical location of the electronic device 200 by using the information related to a geometrical location as a search condition.

The electronic device 200 can collect information related to a preview image. For example, the information related to a preview image can be metadata of an image. In various embodiments, the information related to a preview image can include not only the image data but also at least one of a photographing time, exposure, use of a flash light, resolution, photograph size, film speed (ISO), aperture value (F value), white balance (WB), and shutter speed (T value).

Generally, an electronic device 200 taking a digital image can store information of the electronic device 200 itself and information related to a photograph together with image data at every time of taking a photograph.

The electronic device 200 searches photographing information based on the identified information at step 411. The identified information can be one of the current location information, environment information (for example, weather information), and information related to a preview image obtained at step 409.

In various embodiments, the electronic device 200 can search an image having information identical or similar to information stored in another electronic device 104 or a server 106 through a network 162 based on the identified information.

The image having information identical or similar to the identified information can include photographing information. For example, the photographing information can be information included in the image having information identical or similar to the identified information. The photographing information can include image data and/or metadata. The photographing information can include not only the image data included in the image having information identical or similar to the identified information but also information related to an image. For example, the photographing information can include metadata such as a photographing time, exposure, use of a flash light, resolution, photograph size, film speed (ISO), aperture value (F value), white balance (WB), and shutter speed (T value).

The electronic device 200 obtains photographing information at step 413. The electronic device 200 searches an image having information identical or similar to the identified information, and extracts or obtains photographing information from the found image at step 413. The processor 120 searches an image having information identical or similar to the identified information, and extracts or obtains photographing information from the found image at step 413. The photographing information can be obtained by selecting a portion of the found image based on the frequency of searching or the frequency of recommendation.

The electronic device 200 generates at least one suggested image based on the obtained photographing information at step 415.

The processor 120 analyzes the obtained photographing information and controls the camera module 291 corresponding to the obtained photographing information. The camera module 291 can capture an image displayed in the display 260 based on the photographing information obtained under the control of the processor 120. The camera module 291 can generate a suggested image by applying the obtained photographing information to a preview image displayed in the display 260 and capturing an image of an external subject.

The electronic device 200 can generate an image applied to the preview image based on the obtained photographing information as a suggested image. The electronic device 200 according to various embodiments of the present disclosure can generate the suggested image without notifying a user.

The electronic device 200 according to various embodiments of the present disclosure can generate a suggested image by searching an image having a similar current location, current weather, and preview image through the network 162, obtaining photographing information included in the found image, and controlling the camera module 291 based on the obtained photographing information. The suggested image can be an image of a subject captured by applying the obtained photographing information. The electronic device 200 stores the suggested image in the memory 230 before receiving a user input, and can delete the suggested image from the memory 230 if a user input for selecting the suggested image is not generated.

The electronic device 200 displays the suggested image on an image currently being displayed in the display 260 at step 417. The electronic device 200 can display the suggested image instead of a preview image in the display 260 at step 417.

In various embodiments, the electronic device 200 can display the suggested image in the display 260 by overlapping on the currently being displayed preview image at step 417. The electronic device 200 can display the suggested image on an image currently being displayed in the display 260 in a thumbnail form. The electronic device 200 can overlay the suggested image on the preview image by processing to a transparent or semi-transparent form (for example, ghost shot). The electronic device 200 can display the suggested image on an image currently being displayed in the display 260 by processing to a transparent or semi-transparent form and resizing to a thumbnail. The electronic device 200 can display at least one suggested image on the image being displayed in the display 260.

The electronic device 200 identifies a user input for selecting a suggested image at step 419.

In an embodiment, the user input for selecting a suggested image can be made by touching the suggested image being displayed on a touch screen of the display 260. In various embodiments, the user input for selecting a suggested image can be made by touching a physical button, key or touch button. In various embodiments, the user input for selecting a suggested image can be made by a user's voice input for commanding to select the suggested image.

If the user input for selecting a suggested image is received, the electronic device 200 stores the suggested image at step 421. The user can select at least one suggested image, and the electronic device 200 can store the at least one suggested image.

The electronic device 200 can store the at least one suggested image in the memory 230, and control the at least one suggested image through an album application 383.

The electronic device 200 can store the suggested image in the memory 230 before receiving a user input. If the suggested image is selected by a user input, the suggested image is maintained in the memory 230, and if the suggested image is not selected by the user input, the suggested image can be deleted from the memory 230.

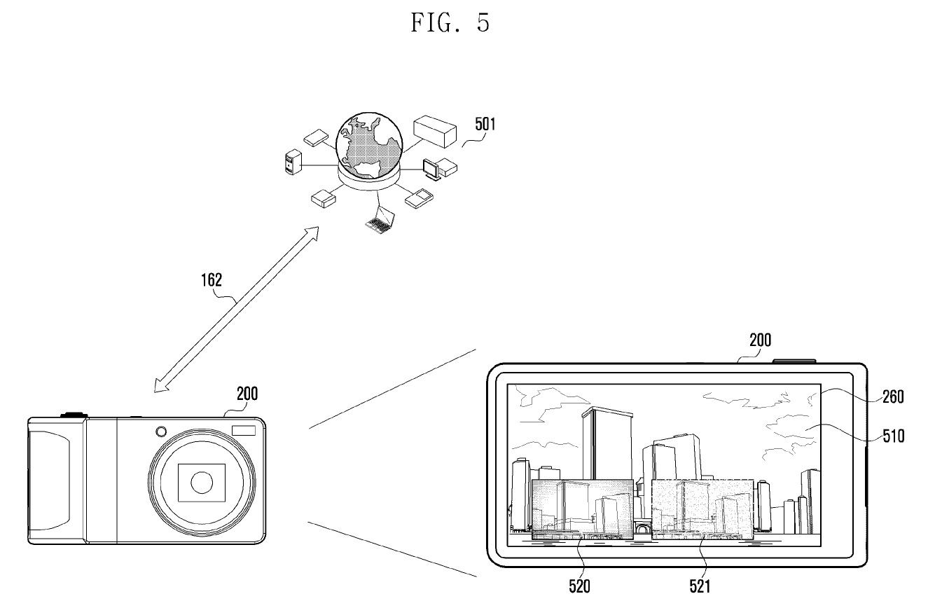

FIG. 5 is a schematic drawing illustrating a method for photographing in an electronic 200 device according to various embodiments of the present disclosure.

The electronic device 200 can search a current location, current weather, and image similar to a preview image through an internet 501, and obtain photographing information included in the found image by connecting to the internet 501 through a network 162.

By controlling the camera module 291, the electronic device 200 generates at least one suggested image 520 and 521 of which photographing information is applied to the preview image based on the obtained photographing information. The electronic device 200 can process the at least one suggested image 520 and 521 to a transparent or semi-transparent form, and display on a display 260 by resizing the suggested image to a thumbnail and overlaying on an image 510 currently being displayed on the display 260.

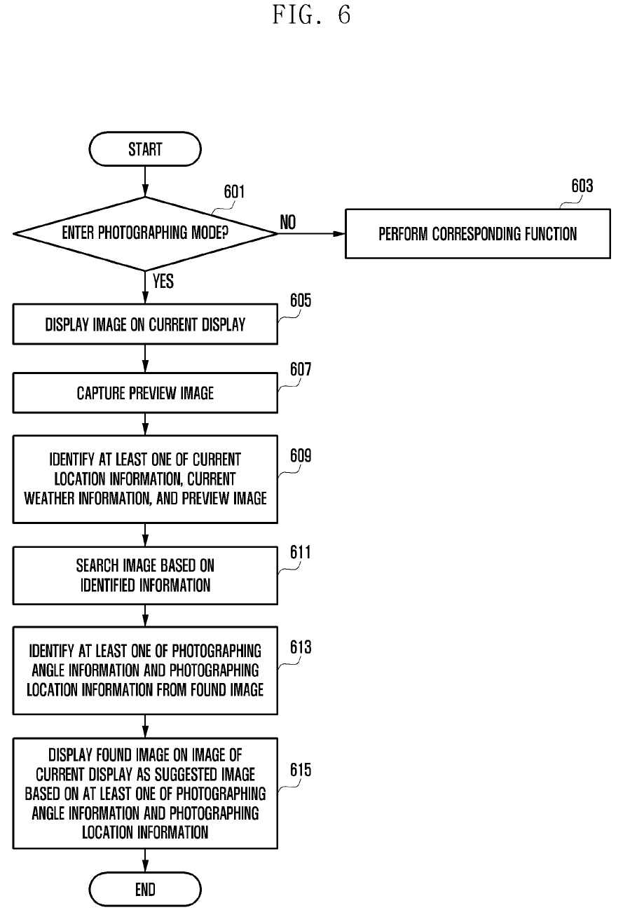

FIG. 6 is a flowchart illustrating a method for photographing in an electronic device 200 according to various embodiments of the present disclosure.

The electronic device 200 identifies entering a photographing mode at step 601. If a request for performing a photographing operation is received from a user, the processor 120 of the electronic device 200 can control the camera module 291 correspondingly.

In various embodiments, if a request for performing a photographing operation of the camera module 291 is received from a user, the processor 120 can control the operation of the camera module 291 and a camera application 376.

In various embodiments, if a request for executing the camera application 376 is received, the processor 120 of the electronic device 200 can control the operation of the camera module 291 and the camera application 376.

If not entered the photographing mode, the electronic device 200 proceeds to step 603, and performs a corresponding function which is currently being executed.

If entered the photographing mode, the electronic device 200 displays an image currently being displayed in the display 260 as a preview image at step 605.

In various embodiments, the processor 120 can properly convert an image input through a lens and a camera sensor of the camera module 291 according to a predetermined output frame rate and display the image in the display 260 as a preview image. For example, the preview image can be a still image or a moving image.

The electronic device 200 captures the image currently being displayed in the display 260 as a preview image at step 607.

In various embodiments, the electronic device 200 can capture an image currently being displayed in the display 260 as a preview image. If a user doesn't give a command for capturing the image displayed in the display 260 for a predetermined time, the electronic device 200 can automatically capture the image currently being displayed in the display 260.

In various embodiments, when capturing the preview image, the electronic device 200 may not notify the capturing a preview image to the user. In another embodiment, when capturing the preview image, the electronic device 200 can output an alarm sound through the audio module or an alarm image through the display 260 so that the user can recognize the capturing a preview image.

Another electronic device 100 identifies at least one of current location information of the electronic device 200, environment information (for example, weather information), and information related to a preview image at step 609.

The electronic device 200 can collect information related to a geometrical location of the electronic device 200 through a communication module. For example, the processor 120 can identify the current location of the electronic device 200 through a GPS module 227. The GPS module 227 can receive location information including a latitude, longitude, altitude, and direction from satellites under the control of the processor 120.

The electronic device 200 can collect information related to a position or a posture of the electronic device 200 through a sensor module 240. For example, the processor 120 can collect information related to a position or a posture of the electronic device 200 by using a gesture sensor 240A, gyro sensor 240B, and/or acceleration sensor 240E included in the sensor module 240.

In various embodiments, the current location information of the electronic device 200 identified at step 609 can include information related to a geometrical location of the electronic device 200 and/or information related to a position or a posture of the electronic device 200.

In various embodiments, the electronic device 200 can collect environment information (for example, weather information) by using an air pressure sensor 240C and/or a temperature/humidity sensor 240J. The electronic device 200 can collect the environment information (for example, weather information) through a network 162 based on the information related to a geometrical location of the electronic device 200. For example, the electronic device 200 can collect the environment information (for example, weather information) corresponding to the information related to a geometrical location of the electronic device 200 through an internet or a server 106 by using the information related to a geometrical information of the electronic device 200 as a search condition.

The electronic device 200 can collect information related to a preview image. The information related to a preview image can be metadata of an image. In various embodiments, the information related to a preview image can include not only the image data but also at least one of a photographing time, exposure, use of a flash light, resolution, photo size, film speed (ISO), aperture value (F value), white balance (WB), and shutter speed (T value).

The electronic device 200 searches an image based on the identified information at step 611.

In various embodiments, the electronic device 200 can search an image having information identical or similar to the identified information from another electronic device 104 or a server 106 through a network 162. The electronic device 200 can search an image having information identical or similar to the identified information from the internet through the network 162.

The electronic device 200 obtains at least one of photographing angle information and photographing location information from the found image at step 613. In order to obtain the photographing angle information and the photographing location information, the electronic device 200 can calculate a photographing angle and a location by using an image analysis program included in the electronic device 200.

When obtaining the photographing angle information and the photographing location information from the found image, the electronic device 200 can obtain the photographing information by selecting a portion of the found image based on the frequency of searching and the frequency of recommendation.

The electronic device 200 displays the found image on an image currently being displayed in the display 260 as a suggested image based on at least one of the photographing angle information and the photographing location information at step 615. In various embodiments, the electronic device 200 can display the suggested image on the image currently being displayed in the display 260 as a thumbnail. The electronic device 200 can display the suggested image by processing to a transparent or semi-transparent form (for example, ghost shot) and overlaying on the image currently being displayed in the display 260. The electronic device 200 can display the suggested image on the image currently being displayed in the display 260 by processing to a transparent or semi-transparent form and resizing to a thumbnail. The electronic device 200 can display one or more suggested images when displaying on the image currently being displayed in the display 260.

If the user moves the electronic device 200 to the photographing location and angle of the suggested image, the electronic device 200 can perform the steps 401 to 423 of FIG. 4. Although the user doesn't move the electronic device 200 to the photographing location and angle of the suggested image, the electronic device 200 can perform the steps 401 to 423 of FIG. 4 according to a user's operation.

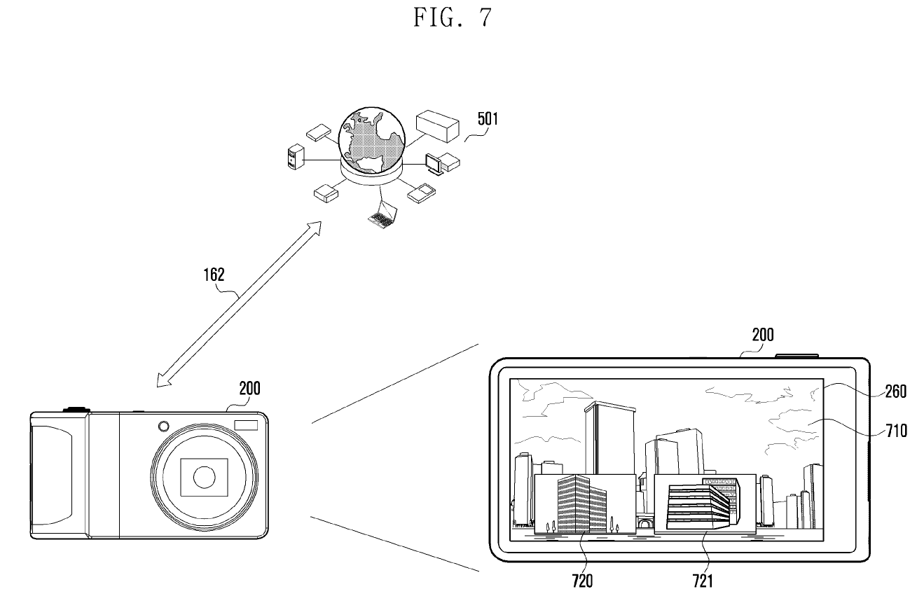

FIG. 7 is a schematic drawing illustrating a method for photographing in an electronic 200 device according to various embodiments of the present disclosure.

The electronic device 200 can connect to an internet 501 through a network 162, search an image having a similar location, weather, and preview image through the internet 501, and obtain photographing information included in the found image.

At least one suggested image 720 and 721 are displayed on an image 710 currently being displayed in the display 260 based on the found image. The electronic device 200 can overlay the at least one suggested image 720 and 721 on the image 710 currently being displayed in the display 260 by processing to a transparent or semi-transparent form and resizing to a thumbnail.

FIG. 8 is a flowchart illustrating a method for photographing in an electronic device 200 according to various embodiments of the present disclosure.

The electronic device 200 identifies entering a photographing mode at step 801. If a request for performing a photographing operation through a camera module 291 is received from a user, a processor 120 of the electronic device 200 can control the operation of a camera module 291 correspondingly.

In various embodiments of the present disclosure, if the request for performing a photographing operation through the camera module 291 is received from the user, the processor 120 can control the operation of the camera module 291 and a camera application 376.

In various embodiments, if a request for executing the camera application 376 is received, the camera module 291 and the camera application 376 can operate under the control of the processor 120 of the electronic device 200.

If not entered the photographing mode, the electronic device 200 branches off to step 803 and performs a corresponding function which is currently being executed.

If entered the photographing mode, the electronic device 200 displays an image currently being displayed in the display 260 as a preview image at step 805.

In various embodiments, the processor 120 can display a preview image in the display 260 by properly converting an image input through a lens and a camera sensor of the camera module 291 according to a predetermined output frame rate. For example, the preview image can be a still image or a moving image.

The electronic device 200 captures the image currently being displayed in the display 260 as a preview image at step 807.

In various embodiments, the electronic device 200 can capture an image being displayed in the display 260 as a preview image. If a user doesn't give a command for capturing the image currently being displayed in the display 260 for a predetermined time, the electronic device 200 can store the image currently being displayed in the display 260 as a preview image.

In various embodiments, when the electronic device 200 captures a preview image, the electronic device 200 may not notify the capturing a preview image to a user. Alternatively, when the electronic device 200 captures a preview image, the electronic device 200 can output an alarm sound through an audio module 280 or an alarm image through the display 260 so that the user can recognize the capture of the preview image capture.

An electronic device 100 identifies at least one of current location information, environment information (for example, weather information), and information related to the preview image of the electronic device 200 at step 809.

The electronic device 200 can collect information related to a geographical location of the electronic device 200 through a communication module. For example, the processor 120 can identify the current location of the electronic device 200 through a GPS module 227. The GPS module 227 can receive a latitude, longitude, altitude, and direction of the electronic device 200 from satellites under the control of the processor 120.

The electronic device 200 can collect information related to a position or a posture of the electronic device 200 through a sensor module 240. For example, the processor 120 can collect information of a declination, location, and posture of an electronic device 240 by using a gesture sensor 240A, gyro sensor 240B, and/or acceleration sensor 240E included in the sensor module 240.

In various embodiments, the current location information of the electronic device 200 identified at step 809 can include information related to a geometrical location and/or information related to a position or a posture of the electronic device 200.

In various embodiments, electronic device 200 can collect environment information (for example, weather information) by using an air pressure sensor 240C and/or a temperature/humidity sensor 240J. The electronic device 200 can collect environment information (for example, weather information) corresponding to the information related to a geometrical location of the electronic device 200 through a network 162. For example, the electronic device 200 can collect environment information (for example, weather information) corresponding to the information related to a geometrical location of the electronic device 200 by using the information related to a geometrical location as a search condition.

The electronic device 200 can collect information related to a preview image. For example, the information related to a preview image can be metadata of an image. In various embodiments, the information related to a preview image can include not only the image data but also at least one of a photographing time, exposure, use of a flash light, resolution, photograph size, film speed (ISO), aperture value (F value), white balance (WB), and shutter speed (T value).

The electronic device 200 searches an image based on the identified information at step 811.

In various embodiments, the electronic device 200 can search an image having information identical or similar to information stored in another electronic device 104 or a server 106 through a network 162 based on the identified information. The electronic device 200 can search an image having information identical or similar to the identified information from the internet through the network 162.

The electronic device 200 obtains at least one of photographing angle information and photographing location information from the found image at step 813. In order to obtain the photographing angle information and the photographing location information, the electronic device 200 can calculate a photographing angle and a location by using an image analysis program included in the electronic device 200.

When obtaining the photographing angle information and the photographing location information from the found image, the electronic device 200 can obtain the photographing information by selecting a portion of the found image based on the frequency of searching and the frequency of recommendation.

The electronic device 200 displays guide information on an image currently being displayed in the display 260 based on at least one of the obtained photographing angle information and photographing location information at step 815. The guide information means a GUI indicating a movement direction location of the electronic device 200, and a user can move the electronic device 200 to a proper photographing angle and location by using a blinking element or an element having a changed transparency in the GUI.

If the user moves the electronic device 200 to the proper photographing angle and location, the electronic device 200 can perform the steps 401 to 423 of FIG. 4. Although the user doesn't move the electronic device to the proper photographing angle and location, the electronic device 200 can perform the steps 401 to 423 of FIG. 4 according to a user's operation.

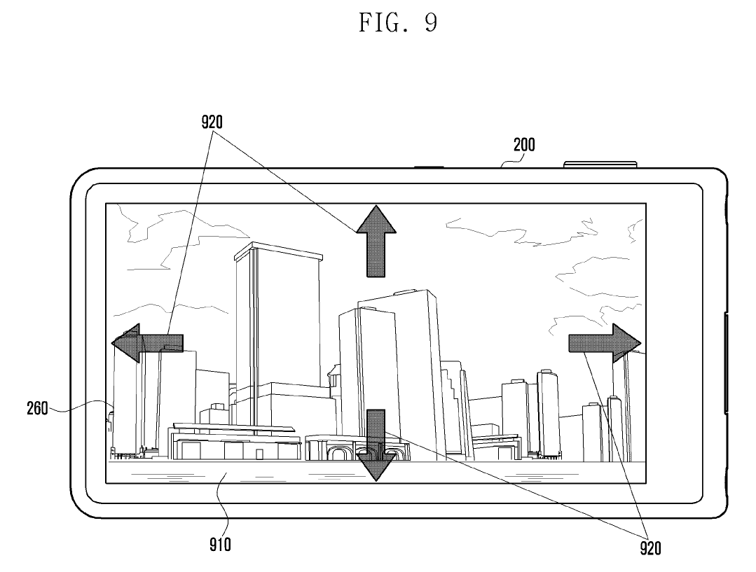

FIG. 9 is a schematic drawing illustrating a method for photographing in an electronic 200 device according to various embodiments of the present disclosure.

The electronic device 200 can process guide information 920 in a transparent or semi-transparent form, and display in the display 260 by overlapping on an image 710 currently being displayed in the display 260.

An electronic device and a method for photographing according to the present disclosure enables a user to obtain an optimum image by providing diversified photographing information in real time for the user.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for photographing in an electronic device, the method comprising:
displaying a preview image on a display;
identifying at least one of current location information, environment information, and information related to the preview image of the electronic device; and
searching and obtaining photographing information based on the identified information.

2. The method of claim 1, further comprising:
generating a suggested image by applying the obtained photographing information to the preview image.

3. The method of claim 2, further comprising:
displaying the suggested image on the display.

4. The method of claim 3, further comprising:
storing the suggested image if a user input for selecting the suggested image is received.

5. The method of claim 1, further comprising:
searching for an image based on the identified information; and
obtaining at least one of photographing angle information or photographing location information from the image.

6. The method of claim 5, further comprising:
displaying the image on the display as a suggested image based on at least one of the obtained photographing angle information and the obtained photographing location information.

7. The method of claim 5, further comprising:
generating guide information based on at least one of the obtained photographing angle information and the obtained photographing location information, and
displaying the guide information on the display.

8. The method of claim 6, wherein the suggested image is semi-transparent.

9. The method of claim 6, wherein the suggested image is resized to a thumbnail.

10. The method of claim 1, wherein the electronic device comprises at least one of an air pressure sensor, temperature sensor or humidity sensor.

11. An electronic device comprising:
a communication module;
a camera module;
a display;
a memory; and
a processor,
wherein the processor is configured to control to:
display a preview image obtained from the camera module on the display;
identify at least one of current location information, environment information, and information related to the preview image; and
search for and obtain photographing information through the communication module based on the identified information.

12. The electronic device of claim 11, wherein the processor is configured to generate a suggested image by controlling the camera module to apply the obtained photographing information to the preview image.

13. The electronic device of claim 12, wherein the processor is configured to control the display to display the suggested image.

14. The electronic device of claim 13,
wherein the processor controls the memory to store the suggested image if a user input for selecting the suggested image is received.

15. The electronic device of claim 11, wherein the processor is configured to:
search for an image through the communication module based on the identified information; and
obtain at least one of photographing angle information and photographing location information from the found image.

16. The electronic device of claim 15, wherein the processor is configured to control the display to display the found image as a suggested image based on at least one of the obtained photographing angle information and the obtained photographing location information.

17. The electronic device of claim 15, wherein the processor is configured to control the display to display guide information based on at least one of the obtained photographing angle information and the obtained photographing location information.

18. The electronic device of claim 16, wherein the suggested image is semi-transparent.

19. The electronic device of claim 16, wherein the suggested image is resized to a thumbnail.

20. The electronic device of claim 11, wherein the electronic device comprises at least one of an air pressure sensor, temperature sensor or humidity sensor.
